(19) United States
(12) Patent Application Publication
(10) Pub. No.: US 2005/0240473 A1
(43) Pub. Date: Oct. 27, 2005

(54) System and method of point-of-sale manufacturer rebate program

(76) Inventors: James R. Ayers JR., Tucson, AZ (US); John Friend, Tucson, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/066,889

(22) Filed: Feb. 24, 2005

Related U.S. Application Data
(60) Provisional application No. 60/564,869, filed on Apr. 22, 2004.

(51) Int. Cl. G06F 17/60

(52) U.S. Cl. 705/14; 705/2

(57) ABSTRACT

A manufacturer rebate processing program uses a program administrator to implement the rebate program. A rebate program card is issued to consumers to identify the rebate qualifying product. The consumer presents the card to the merchant when making a purchase. The purchase transaction from the merchant is forwarded to the rebate program administrator which in turn forwards a rebate request to the manufacturer for the rebate qualifying product. The rebate qualifying product may be a prescription drug or a non-prescription health care item. The program administrator further identifies restricted use accounts such as health savings accounts to pay a qualifying portion of the consumer purchase transaction. The program administrator receives rebate funds from the manufacturer and reconciles the consumer purchase transaction with the rebate funds from the manufacturer. The rebate funds may be deposited into a merchant account or a consumer account to reconcile the consumer purchase transaction.

### CLAIM OF DOMESTIC PRIORITY

The present non-provisional patent application claims priority to provisional application Ser. No. 60/564,869, entitled “Manufacturer Automated Point of Service Rebate Program”, filed on Apr. 22, 2004.

### FIELD OF THE INVENTION

The present invention relates in general to consumer rebate programs and, more particularly, to point-of-sale manufacturer rebate program available to consumers.

### BACKGROUND OF THE INVENTION

In the retail sales industry, the stereotypical chain of commerce can be viewed as including manufacturers, distributors, retail outlets, and consumers. The manufacturer produces one or more goods or services. The distributor can be one or more middlemen positioned between the manufacturer and the consumer. The consumer purchases the product from the retail outlet, which is usually the last link in the distribution supply chain. Of course, the retail outlet sells many different brands and choices to meet the customer's wants and needs. Depending on the wide spread demand and use of each product, the consumer may find all forms of brands, quantities, shapes, packaging, and quality. The more popular and useful the product, the more likely it is that the retail outlet will carry many purchasing choices from a variety of manufacturers. The price of the product will be reflected in part by the features and quality of the product, as well as the various choices offered for purchase by the retail outlet. The terms of the distributors can also have a material impact on pricing.

Manufacturers will have their own research, development, production, and marketing strategy. Some manufacturers are known for their quality, features, benefits, packaging, reputation, and name recognition. Products from such higher-end manufacturers are generally referred to as name brands. Other manufacturers will use one or more cost cutting measures to reduce the production costs and thereby reduce the ultimate retail price of their product to the consumer. Products from such lower-end manufacturers are commonly referred to as generic brands. Generic brands are usually less expensive to the consumer than name brands at the point of sale. While manufacturers may not all agree, there is a general perception in the mind of many consumers that the quality and effectiveness of name brands is better than generics. Nonetheless, in many situations, be it driven by budget constraints or otherwise, many consumers will still purchase the generic brands over the name brands.

In some industries, such as pharmaceuticals, the selection of name brand drugs versus competitive name brand drugs or generic drugs may be dictated by many different interests and pressures. Sometimes the health benefit administrator may create consumer financial incentives and disincentives that prefer one drug product and/or limit access to another. In such cases, the cost-conscious consumer may be driven in the direction of the preferred drug product. Other consumers may still be willing to spend more to purchase the disadvantaged product because they may have more confidence in efficacy of the more costly drug, or may have experienced fewer side effects or adverse reactions for that drug product.

Pharmaceutical manufacturers are well aware of the many factors driving the drug industry and consumer purchasing decisions. There are many competing interests when it comes to drugs. Health benefit administrators may be trying to cut costs while maximizing administrative revenues, physicians are trying to provide effective treatment for the patient's medical condition, shareholders are interested in profitability, and consumers are concerned about their own costs and therapeutic benefit as well as side effects of the drug. While price is a major consideration for consumers, most people try to balance price with a drug that will do the job.

While the various pharmaceutical manufacturers each have certain advantages and protection in terms of name recognition, therapeutic advances from their R&D, and patent protection for a period of time, all manufacturers continually search for the marketing strategies and business opportunities that will increase sales and profitability. Likewise, pharmacies must compete for business, and consumers look for the best overall value consisting of price, selection, service, and convenience. Any marketing strategy that provides benefits for the pharmacy, consumer, and pharmaceutical company alike would be most desirable for all.

### SUMMARY OF THE INVENTION

In one embodiment, the present invention is a computer implemented method of processing manufacturer rebates for consumer purchases, comprising receiving a consumer purchase transaction from a merchant, providing for submission of the consumer purchase transaction to a rebate program administrator which in turn accesses rebate funds from a manufacturer for a rebate qualifying product within the consumer purchase transaction, and reconciling the consumer purchase transaction with the rebate funds from the manufacturer.

In another embodiment, the present invention is a method of processing rebates for consumer purchases, comprising receiving a consumer purchase transaction including a rebate qualifying product, accessing rebate funds from a manufacturer for the rebate qualifying product, and reconciling the consumer purchase transaction with the rebate funds from the manufacturer.

In another embodiment, the present invention is a method of processing consumer purchases, comprising receiving a consumer purchase transaction including a qualifying product, identifying a restricted use account to pay for a portion of the consumer purchase transaction attributed to the qualifying product, determining net proceeds from the restricted use account which are used to pay the portion of the consumer purchase transaction attributed to the qualifying product, and reconciling the consumer purchase transaction with the net proceeds funds from the restricted use account.

In another embodiment, the present invention is a computer program product usable with a programmable computer processor having a computer readable program code embodied therein, comprising computer readable program code which receives a consumer purchase transaction from a merchant for a rebate qualifying product, computer readable program code which accesses rebate funds from a manufacturer for the rebate qualifying product, and computer readable program code which reconciles the consumer purchase transaction with the rebate funds from the manufacturer.

In another embodiment, the present invention is a computer system for processing rebates for consumer purchases, comprising means for receiving a consumer purchase transaction from a merchant for a rebate qualifying product, means for accessing rebate funds from a manufacturer for the rebate qualifying product, and means for reconciling the consumer purchase transaction with the rebate funds from the manufacturer.

### BRIEF DESCRIPTION OF THE DRAWINGS

FIG. 1 illustrates the manufacturer rebate program for a supply chain as applied to consumer products;

FIGS. 2a-2b illustrates front and back views of a rebate program card;

FIG. 3 illustrates a flowchart of the point-of-sale manufacturer rebate program;

FIG. 4 illustrates a general computer system for executing the point-of-sale manufacturer rebate program; and

FIG. 5 illustrates a computer communication network for processing consumer transactions and the rebate program.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Rebates and electronic coupons (e-coupons) based on product purchases is one type of marketing strategy available to manufacturers. Rebates program as described herein apply to many different types of consumer and business products and services. In general, a rebate program administrator or service provider facilitates point-of-sale manufacturer rebates to consumers. The program captures specific data related to the product purchase, e.g., product identification, characteristics, quantity, and price, as determined at the time of purchase, and applies the manufacturer rebate to the purchase price, resulting in a reduction in the net out-of-pocket price to the consumer. The program administrator settles up with the retail outlet in due course. Alternatively, the rebate can be made available to the consumer in the form of a stored value card for other purchases by the consumer.

For the basis of the present discussion, the rebate program will be described for the prescription drug marketplace. The program mechanics are readily expandable to many other consumer products and services. For example, the rebate program can be applied to non-prescription health care products, over the counter drugs, food, clothing, electronic equipment, household products, home furnishings, and other durable goods, just to name a few. The rebate program is useful for a variety of consumer services such as health care services and automotive maintenance services.

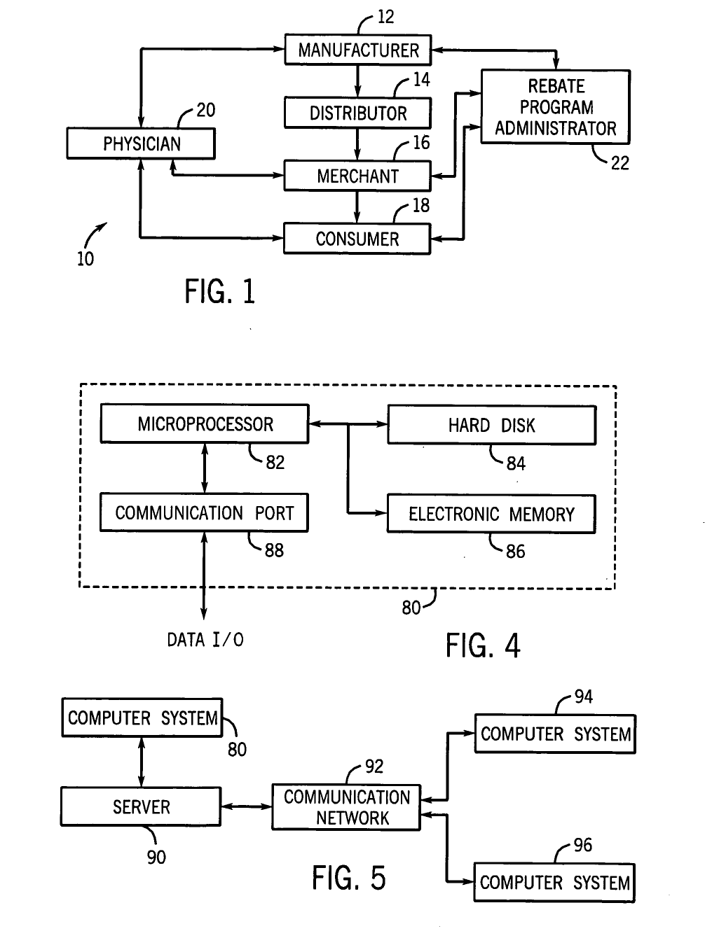

Referring to FIG. 1, a point-of-sale manufacturer rebate program 10 is shown as a supply chain or stream of commerce as applied to consumer products. Manufacturer 12 can be a pharmaceutical company which produces prescription drugs and pharmaceutical products. Manufacturer 12 sells its prescription drugs to distributor 14, which in turn vends to retail outlet or merchant 16. The retail outlet 16 may be a pharmacy, hospital, or other authorized merchant or dispenser of prescription drugs. Consumer 18 patronizes retail outlet or pharmacy 16 to purchase prescription drugs. Consumer 18 may be a person seeking prescription drugs for personal use, or a business authorized to re-sale prescription drugs. Physician 20 works in conjunction with manufacturer 12 and/or distributor 14, usually via a drug representative. Physician 20 also interacts with pharmacy 16 and consumer or patient 18. Rebate program administrator 22 works with manufacturer 12 and/or distributor 14, pharmacy 16, consumer 18, and physician 20 to setup, operate, and administer certain aspects of the point-of-sale rebate program 10.

Assume for the present discussion that manufacturer 12 decides to sponsor or participate in point-of-sale rebate program 10. Manufacturer 12 may be a large pharmaceutical company producing and selling name brand drugs. Manufacturer 12 may express concern over the market share being held by the growing number of competing drug producers, or simply be interested in establishing a communication link to collect information regarding consumer buying habits. Manufacturer 12 may be a small drug producer interested in increasing its market share and building consumer loyalty.

Rebate program administrator 22 is a third party service provider in the business of helping manufacturers, pharmacies, and consumers alike link common interests and achieve the most efficient and cost effective access to products and services. Rebate program administrator 22 solicits manufacturer 12 to participate in point-of-sale rebate program 10. Manufacturer 12 agrees to a marketing program where they give rebates to certain consumers under the rebate program. Rebate program administrator 22 also works with pharmacy 16 to coordinate their participation. Finally, the program administrator 22 may advertise or interact with consumers 18 to promote participation in the rebate program.

Manufacturer 12 elects to use rebate program administrator 22 to implement and administer the rebate program. As mentioned above, program administrator 22 coordinates the rebate program with one or more pharmacies 16. The pharmacy can be any retail or business outlet authorized by state and federal law to dispense prescription medication. The pharmacy may conduct business on-line with prescription transactions handled electronically and through mail service. The pharmacy 16 agrees to the process established and administered by program administrator 22 for the point-of-sale manufacturer rebate program 10. The pharmacy 16 benefits by offering a service which provides incentives to consumers 18 to have prescriptions filled in their store, thereby increases its sales and profitability.

Physician 20 also has an interest in the rebate program. Physician 20 benefits from the confidence that the patient will actually purchase the exact prescribed medication and won't switch out the prescribed drug for a cheaper alternative, or worse yet, select an over the counter substitute because of cost issues. The patient's prognosis and progress under the prescribed treatment program is in part based on following the physician's instructions.

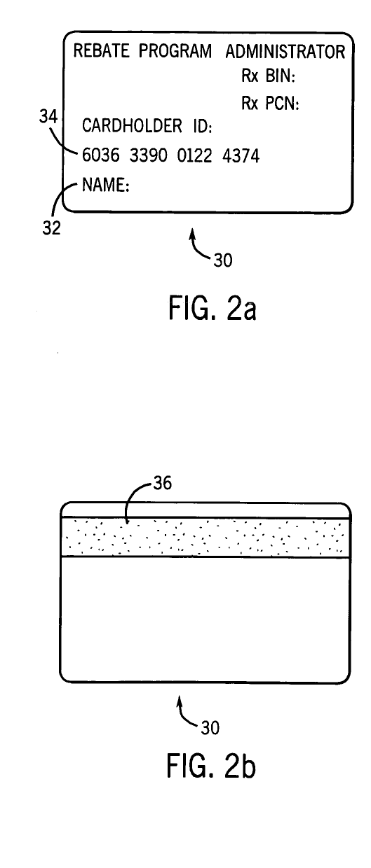

With the manufacturer and pharmacy on board, program administrator 22 needs to get the rebate program in the hands of consumer 18. In one embodiment, program administrator 22 issues a rebate program identification card 30 as shown in FIG. 2a. The rebate program identification card 30 has the form factor of a credit card. There is a participant name 32 and cardholder identification number 34 printed on the front of card 30. The back of card 30 has the cardholder identification encoded in a magnetic strip 36 as shown in FIG. 2b. The rebate program identification card 30 may also use other electronic scanning and reading techniques such as RFID and optical recognition.

Consumer 18 can get access to rebate program card 30 in several different ways, which in part depend on the rebate program policy and guidelines as established by manufacturer 12 or as negotiated through rebate program administrator 22. Manufacturer 12 may want the rebate program to be available to only certain classes of consumers, e.g., low income individuals, or patients with certain illnesses. Manufacturer 12 will typically limit the rebate program to only certain prescription drug products or classes of products which the manufacturer wants to promote. In one scenario, the rebate program cards are distributed to physicians 20 by manufacturer representatives. The physicians give the cards to qualifying patients under the rebate program. Alternatively, the manufacturer 12 may issue the cards directly to the consumer, or delegate the distribution of the cards to rebate program administrator 22. In other cases, the point-of-sale rebate program 10 may be made generally available to all consumers, in which case rebate program administrator 22 is free to sign up any and all interested parties. In any case, the distribution of rebate program cards 30 to targeted consumers will require marketing, promotional, and advertising materials and efforts on the part of rebate program administrator 22, manufacturer 12, and/or pharmacy 16.

In another embodiment, the point-of-sale manufacturer rebate program 10 can be implemented without issuing rebate program cards to consumers 18. The manufacturer 12 and pharmacy 16 may agree to offer the rebate to qualifying consumers at the time of sale. When consumer 18 is having a prescription filled with pharmacy 16, the pharmacist can notify consumer 18 that a rebate is available on the prescribed drug, or that he or she can recommend another rebate qualified prescribed drug from manufacturer 12. Consumer 18 can select the rebate and receive the benefit on the spot, without a rebate program card or even prior knowledge of the rebate program.

Consider the following example which demonstrates one implementation of point-of-sale manufacturer rebate program 10. Physician 20 prescribes a certain prescription drug for patient 18 for treatment of a diagnosed medical condition. Physician 20 provides the patient with rebate program identification card 30 as distributed by the manufacturer drug representative. As mentioned above, the patient may also acquire rebate program card 30 from program administrator 22, manufacturer 12, or merchant 16.

Patient (consumer) 18 contacts pharmacy 16 either in person, by phone, or electronically, to have the prescription filled. Consumer 18 may be on a prescription drug program through their health care provider or insurance company. Assume the cost of the prescribed drug is $150 and the consumer 18 has a co-pay of $50. The insurance company picks up the other $100 through its benefits claims program with the pharmacy. In real-time electronic communication with the insurance company, the pharmacist will be notified that consumer 18 owes a $50 co-pay toward the purchase of the drug. Consumer 18 presents rebate program identification card 30 to the pharmacist. In the present example, the manufacturer rebate for the qualifying prescription drug to the consumer is $30. The pharmacist enters the rebate program card 30 into the electronic system which confirms the qualification of the rebate program and authorizes the collection of only $20 as proper amount due from consumer 18, i.e., the difference between the co-pay and the rebate.

The consumer purchase transaction is entered into the pharmacy's computer system, e.g., the pharmacist reads the bar code associated with the drug purchase into the electronic cash register and further scans in the information from magnetic strip 36 on the back of rebate program card 30. Pharmacy 16 charges consumer 18 the amount of $20. Consumer 18 pays the $20 and receives the prescription. After receiving the net $20 from consumer 18, pharmacy 16 is still due $30, either directly or indirectly from the manufacturer rebate program. The pharmacy 16 collects all such rebate qualifying purchases over a period of time, usually at the end of each business day, and electronically transmits or otherwise submits the rebates to program administrator 22.

Rebate program administrator 22 is the clearing house for the multitude of rebate transactions transpiring daily between multiple consumers, multiple pharmacies, and multiple manufacturers. In one embodiment, manufacturer 12 allocates a set amount of money to program administrator 22 to be used to pay qualifying rebate requests from pharmacy 16. Program administrator 22 holds the rebate funds from manufacturer 12 in a trust account and then accesses the account to pay for the rebate requests. In another embodiment, program administrator 22 electronically transmits rebate requests to manufacturer 12 who then funds the rebate requests as they come in. In either case, program administrator 22 can batch process the rebate transactions from each pharmacy at the end of each cycle, e.g., end of each business day or week, and performs an electronic funds transfer (EFT) to pharmacy 16 to reconcile all rebates outstanding and due. Depending on their operating mode, program administrator 22 directly accesses their manufacturer-funded rebate account directly to make payouts to the pharmacies, or electronically transmits or otherwise submits all qualified rebate transactions to manufacturer 12, who in turn executes an EFT back to program administrator 22 to credit their payouts to the pharmacies. The EFTs are cumulative of the rebates processed in the time period to simplify the accounting process. The manufacturer rebate program 10 may encompass many different manufacturers and many different pharmacies. Program administrator 22 performs the function of accumulating and correlating all individual rebate transactions. Program administrator 22 is able to accumulate all rebates from all respective manufacturers to provide one EFT to each respective pharmacy. Likewise, program administrator 22 is able to accumulate rebates from all pharmacies and effect one EFT from each respective manufacturer to satisfy and reconcile all receivables.

In another embodiment, rebate program card 30 can be set up as a stored value card (SVC) for the benefit of consumer 18. An account is created on behalf of consumer 18. The SVC account can be established with a bank or other financial institution through rebate program administrator 22 to provide a money transfer vehicle from which to pay for consumer purchase transactions or to receive deposits and EFTs from other financial institutions. The SVC account is linked to the SVC 30 and has attributes of a debit card against the consumer's account. SVC 30 can also have attributes of a credit card, i.e., authorizing payment when the purchase exceeds the present balance of the consumer account, as backed by a bank, credit granting financial institution or any other account capable of accepting rebate funds. By using SVC 30, the rebate program administrator 22 can effect the rebate reconciliation process through the individual consumer or pharmacy accounts.

The point-of-sale rebate program 10 also provides for real-time processing of rebate qualified transactions. When the consumer 18 presents rebate program card 30, the pharmacy enters the drug purchase and consumer rebate information into its electronic cash register system. The amount of the rebate is forwarded to program administrator 22 in real-time. Program administrator 22 accesses their manufacturer-funded rebate account to pay pharmacy 16, or forwards the rebate qualified transaction to manufacturer 12 who executes an EFT of funds either directly to pharmacy 16 or through the SVC account and program administrator 22 to pharmacy 16. The rebate funds from manufacturer 12 can also go directly into the SVC account to give consumer 18 the additional money to pay the full co-pay amount, i.e., consumer pay $50 from the SVC account but since $30 was just deposited the real drug cost to consumer 18 is only $20 of their own money. In any case, pharmacy 16 receives its full payment of the co-pay in real-time.

Consider an alternative transaction between consumer 18 and pharmacy 16. In the previous example, consumer 18 pays the $20 co-pay and receives the prescription drug. The remaining $30 of the co-pay comes to pharmacy 16 indirectly from manufacturer 12 in due course. In the alternative transaction, consumer 18 pays the entire $50 co-pay from their own monies and receives the prescription drug. The pharmacy electronically submits the rebate to program administrator 22, but since pharmacy 16 is paid-up with respect to consumer 18, the rebate money from manufacturer 12 is deposited in the consumer's stored value account. When program administrator 22 accesses or receives the rebate funds from manufacturer 12, the monies can be credited directly into the consumer's SVC 30. Consumer 18 can then use the balance available on SVC 30 to make other purchases, e.g., gasoline, groceries, sundries, etc. The pharmacy may even have an affinity program which gives the consumer an extra discount in terms of a percentage, e.g., another 5% savings, off other purchases made in the pharmacy. If the consumer authorizes the rebate to go into the pharmacy affinity plan, i.e., monies can only be used for other purchases at the same store or affiliated store, then consumers receive the additional financial benefit to making further discounted purchases at the same store. The affinity program increases sales for the pharmacy and serves to build customer loyalty.

The point-of-sale rebate program 10 can give consumer 30 great flexibility in determining how to utilize the program. The consumer may want to pay less cash up front and let the pharmacy have the rebate; the consumer may want to get the rebate back directly and use it for other purchases; or the consumer may want to integrate the SVC concept into a credit card to keep their overall finances under one account. While manufacturer 12 may control certain qualifying aspects of the rebate program since they are providing the funding, there are many reasons to turn over certain implementation and utilization details to pharmacy 16 and consumer 18 to make the program more flexible and beneficial to all.

The point-of-sale rebate program 10 can be configured to assign control of certain implementation and utilization details to some combination of manufacturer 12, pharmacy 16, and consumer 18. For example, manufacturer 12 decides which drugs are subject to rebate, amount of the rebate, and which classes of consumers to qualify. Consumer 18 gets to choose the features and attributes of the SVC 30. Pharmacy 16 may determine which stores participate in the rebate program and whether they want to offer an affinity program. In the event the parties should disagree or create a conflict on the implementation details, program administrator 22 would build into rebate program 10 a matrix of selections, options, preferences, priorities, and rules to resolve such conflicts between the interested parties. The rules of the manufacturer rebate program will comply with state and federal laws.

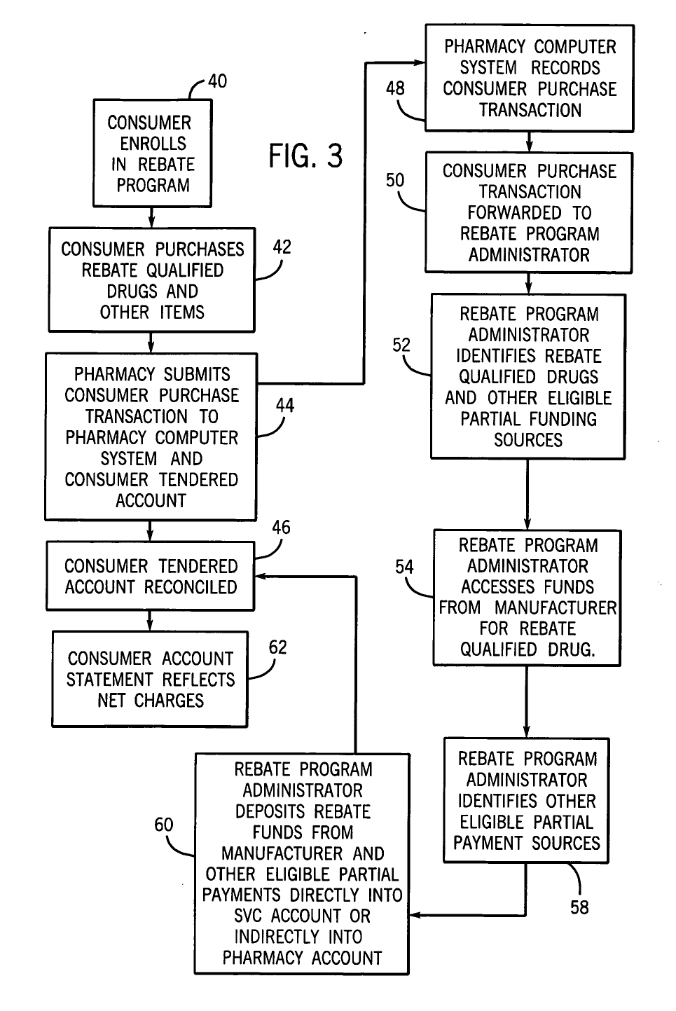

As further explanation, FIG. 3 illustrates a process flowchart of one embodiment of the point-of-sale manufacturer rebate program 10. In step 40, consumer 18 enrolls or registers as a member in the manufacturer rebate program 10. The consumer obtains or registers a rebate program identification card or SVC 30. In activating SVC 30, the consumer 18 may register as a form of identification the SVC account or one or more alternative unique identifiers, e.g., other credit card, debit card, driver's license, or checking account. The consumer 18 may register as the default payment source the rebate program card that they have received from their physician, an SVC account, or one or more alternative payment sources, e.g., other credit card, debit card, retail store card, or checking account supporting general consumer purchases. The consumer may also register the SVC account or one or more alternative accounts, e.g., other credit card, bank debit card, or checking account, as the default deposit account to receive the rebate funds. Rebate program administrator 22 can link the alternative purchase vehicles to the SVC account for the convenience and benefit of the consumer. The registration creates the link between the customer's selected purchase vehicle and the SVC account. The consumer may also enroll in one or more retail affinity programs as described above, or in a restricted use account such as Health Saving Account (HSA), Flexible Spending Account (FSA), or Education Savings account (ESA), as described below. The deposit account, payment sources, affinity programs, and HSA are all linked by rebate program administrator 22 through the SVC 30 or other unique identifier. The consumer 18 authorizes pharmacy 16 to release purchase transaction data to program administrator 22.

In step 42, consumer 18 purchases the rebate qualified prescription drug and possibly other unrelated items from pharmacy 16. The purchased items are entered into the pharmacy's electronic cash register. In most cases, the items are entered by scanning the product barcode to collect stock keeping unit (SKU) or universal product code (UPC) data. In step 44, pharmacy 16 electronically transmits or otherwise submits total charges for all pending consumer purchases, including partial or full co-pays for rebate qualified prescription drug(s), as well as any other items which consumer 18 wants to purchase, to consumer's tendered account. The tendered account can be the SVC account, or other alternative payment sources linked or identified through the SVC account, or an alternative payment source which is provided separately. That is, consumer 18 may provide pharmacy 16 with just SVC 30, which contains all relevant and related account information, or the consumer may give the pharmacy a separate bank debit or credit card for the purchases and SVC 30 or other unique identifier for the rebate. In step 46, the total charges for the purchase(s) made by consumer 18 are received by the consumer's tendered account, e.g., SVC account or alternative bank or financial intuition supporting the payment source, for reconciliation.

In step 48, pharmacy 16 also electronically transmits the complete consumer purchase transaction to its own data warehouse and transaction processing system residing on the pharmacy's computer system for recordation of the sale and processing of the consumer payment source. The consumer purchase transaction includes all relevant information, including consumer information, SKU or UPC data for each item purchased, quantity, date, store location, and employee handling the purchase transaction. In step 50, the consumer purchase transaction is electronically forwarded to program administrator 22, as authorized by consumer 18. In some cases, only the portion of the consumer purchase transaction related to the rebate qualified drug purchase will be sent to program administrator 22. In step 52, program administrator 22 analyses the consumer purchase transaction to identify and confirm rebate qualified items according to the manufacturer rebate program. Rebate program administrator 22 further identifies the appropriate rebate funding source, i.e., manufacturer 12, and potentially other available and eligible partial payment sources, e.g., HSA or FSA, as discussed below.

In step 54, program administrator 22 accesses funds from manufacturer 12 for the rebate qualified drug. As mentioned above, in one case, a rebate request is electronically transmitted or submitted to manufacturer 12, which in turn sources the rebate funds to program administrator 22 for allocation to merchant 16 or consumer 18. Manufacturer 12 may independently confirm and authenticate the rebate request and then provide the qualified rebate funds to program administrator 22 by way of EFT. In another operating mode, the rebate funds are deposited with program administrator 22 in advance and then allocated to merchant 16 or consumer 18 as the consumer purchase transactions containing a rebate qualified drug are received. Again, submission of rebate requests is executed in real-time or in a batch process as described above.

In step 58, program administrator identifies available and eligible partial payment sources or restricted use accounts, such as HSA, FSA, ESA, or Medicare. HSA and FSA accounts are tax-free accounts established by consumer 18 which can be used for certain qualified health care related purchases. Many consumers set aside money on tax-free basis to pay for qualified health care expenses. When consumer 18 purchases a number of items, program administrator 22 can identify which items qualify for HSA, FSA, ESA or Medicare reimbursement using product and program matching algorithms in the program administrator's computer systems. The SKU data from consumer purchase transaction can be compared to a database maintained by program administrator 22 which identifies the restricted use qualified items. For example, the consumer may purchase acetaminophen over the counter, which may qualify under the consumer's HSA account. The acetaminophen will be a line item in the consumer purchase transaction. When program administrator 22 receives the consumer purchase transaction, the administrator's computer matching algorithms compare the products and available programs to identify which products qualify for reimbursement. If the acetaminophen product qualifies for HSA reimbursement, then program administer 22 determines net amount of purchase transaction qualifying under the HSA restricted use account and transfers the monies from the HSA restricted use account to the consumer's SVC account. Program administrator 22 can automatically identify qualified expenses and subsequently withdraw funds from the restricted use account to reimburse the consumer for such expenses, even when the purchases are made using a non-restricted use purchasing vehicle. Program administrator 22 provides consumer 18 with a monthly activity statement disclosing rebates and amounts transferred from the restricted use accounts.

In step 60, program administrator 22 deposits the rebate funds from manufacturer 12 and restricted use reimbursements either directly into the SVC account or indirectly into an account for pharmacy 16. The process returns to step 46 to reconcile the consumer tendered account and/or pharmacy account. The rebate funds and restricted use reimbursements are used to reconcile the consumer purchase transaction. If the consumer paid the co-pay or retail price of the drug less the rebate value, then the rebate funds are used to reconcile the portion of the purchase price still due to the pharmacy. If the consumer paid the entire co-pay or retail price of the drug, then the rebate funds are used to reconcile the amount due to the consumer In step 62, the consumer's account statement reflects net charges of the consumer purchase transaction.

As discussed above, point-of-sale manufacturer rebate or e-coupon program 10 is applicable to many products and services. Pharmacy 16 can apply the rebate program to over the counter medications. Manufacturers may offer rebates on certain products and for frequency customers. The consumer benefits from both the manufacturer rebate and by using HSA funds to pay for a portion of the remainder of the purchase. Virtually any other consumer product or services such as food, clothing, electronic equipment, household products, home furnishings, durable goods, and automotive maintenance services can use the manufacturer rebate program.

The point-of-sale manufacturer rebate program 10 can be implemented as one or more software applications or computer programs residing and operating on a computer system. The computer system may be a stand-alone unit or part of a distributed computer network. The computer is typically electronically interconnected with other computers using communication links such as Ethernet, radio frequency (RF), satellite, telephone lines, optical, digital subscriber line, cable connection, wireless, and other recognized communication standards. The electronic connection link between computers can be made through an open architecture system such as the World Wide Web, commonly known as the Internet. The Internet offers a significant capability to share information, data, and software.

FIG. 4 illustrates a simplified computer system 80 for executing the software program used in processing the manufacturer rebate program. Computer system 80 is a general purpose computer including a central processing unit or microprocessor 82, mass storage device or hard disk 84, electronic memory 86, and communication port 88. Communication port 88 represents a modem, high-speed Ethernet link, or other electronic connection to transmit and receive input/output (I/O) data with respect to other computer systems.

In FIG. 5, computer 80 is shown connected to server 90 by way of communication port 88, which in turn is connected to communication network 92. Server 90 operates as a system controller and includes mass storage devices, operating system, and communication links for interfacing with communication network 92. Communication network 92 can be a local and secure communication network such as an Ethernet network, global secure network, or open architecture such as the Internet. Computer systems 94 and 96 can be configured as shown for computer 80 or dedicated and secure data entry terminals. Computers 94 and 96 are also connected to communication network 92. Computers 80, 94, and 96 transmit and receive information and data over communication network 92.

Computers 80, 94, and 96 can be physically located in any location with access to a modem or communication link to network 92. For example, computer 80 can be located in the rebate program administrator's main office. Computer 94 can be located in the pharmacy's main office. Computer 96 can be located in the manufacturer's main office. Alternatively, the computers can be mobile and follow the users to any convenient location, e.g., remote offices, customer locations, hotel rooms, residences, vehicles, public places, or other locale with electronic access to communication network 92.

Each of the computers runs application software and computer programs, which can be used to display user interface screens, execute the functionality, and provide the features as described above. The software is originally provided on computer readable media, such as compact disks (CDs), magnetic tape, or other mass storage medium. Alternatively, the software is downloaded from electronic links such as the host or vendor website. The software is installed onto the computer system hard drive 84 and/or electronic memory 86, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilation of executable code which performs the functionality of the manufacturer rebate program. The user interacts with the software via keyboard, mouse, voice recognition, and other user interface devices to the computer system.

The software stores information and data generated during the purchase transaction in a database or file structure located on any one of, or combination of, hard drives 84 of the computers 80, 94, 96, and/or server 90. More generally, the information generated during the purchase transaction can be stored on any mass storage device accessible to the computers 80, 94, 96, and/or server 90. The mass storage device for storing the purchase transaction may be part of a distributed computer system.

While one or more embodiments of the present invention have been illustrated in detail, the skilled artisan will appreciate that modifications and adaptations to those embodiments may be made without departing from the scope of the present invention as set forth in the following claims.

1. A computer implemented method of processing manufacturer rebates for consumer purchases, comprising:
receiving a consumer purchase transaction from a merchant;
providing for submission of the consumer purchase transaction to a rebate program administrator which in turn accesses rebate funds from a manufacturer for a rebate qualifying product within the consumer purchase transaction; and
reconciling the consumer purchase transaction with the rebate funds from the manufacturer.

2. The computer implemented method of claim 1, further including depositing the rebate funds into a merchant account to reconcile the consumer purchase transaction.

3. The computer implemented method of claim 1, further including depositing the rebate funds into a consumer account to reconcile the consumer purchase transaction.

4. The computer implemented method of claim 3, wherein the rebate funds deposited into the consumer account are available for other consumer purchase transactions.

5. The computer implemented method of claim 1, wherein the rebate qualifying product is a prescription drug.

6. The computer implemented method of claim 1, wherein the rebate qualifying product is a non-prescription health care related item.

7. The computer implemented method of claim 1, further including issuing a rebate program card to a consumer to identify the rebate qualifying product.

8. The computer implemented method of claim 1, further including identifying a restricted use account to pay for a portion of the consumer purchase transaction attributed to a qualifying product.

9. The computer implemented method of claim 8, wherein the restricted use account is a health saving account, flexible spending account, or educational savings account.

10. The computer implemented method of claim 8, further including determining net proceeds from the restricted use account which are used to pay the portion of the consumer purchase transaction attributed to the qualifying product.

11. The computer implemented method of claim 1, further including registering a consumer to receive the manufacturer rebates.

12. A method of processing rebates for consumer purchases, comprising:
receiving a consumer purchase transaction including a rebate qualifying product;
accessing rebate funds from a manufacturer for the rebate qualifying product; and
reconciling the consumer purchase transaction with the rebate funds from the manufacturer.

13. The method of claim 12, further including depositing the rebate funds into a merchant account to reconcile the consumer purchase transaction.

14. The method of claim 12, further including depositing the rebate funds into a consumer account to reconcile the consumer purchase transaction.

15. The method of claim 14, wherein the rebate funds deposited into the consumer account are available for other consumer purchase transactions.

16. The method of claim 12, wherein the rebate qualifying product is a prescription drug or a non-prescription health care related item.

17. The method of claim 12, further including issuing a rebate program card to a consumer to identify the rebate qualifying product.

18. The method of claim 12, further including identifying additional funding sources for paying a portion of the consumer purchase transaction.

19. The method of claim 12, further including identifying a restricted use account to pay for a portion of the consumer purchase transaction attributed to a qualifying product.

20. The method of claim 19, wherein the restricted use account is a health saving account, flexible spending account, or educational savings account.

21. The method of claim 19, further including determining net proceeds from the restricted use account which are used to pay the portion of the consumer purchase transaction attributed to the qualifying product.

22. A method of processing consumer purchases, comprising:
receiving a consumer purchase transaction including a qualifying product;
identifying a restricted use account to pay for a portion of the consumer purchase transaction attributed to the qualifying product;
determining net proceeds from the restricted use account which are used to pay the portion of the consumer purchase transaction attributed to the qualifying product; and
reconciling the consumer purchase transaction with the net proceeds funds from the restricted use account.

23. The method of claim 22, further including:
accessing rebate funds from a manufacturer for the qualifying product; and
reconciling the consumer purchase transaction with the rebate funds from the manufacturer.

24. The method of claim 23, further including depositing the rebate funds into a merchant account to reconcile the consumer purchase transaction.

25. The method of claim 23, further including depositing the rebate funds into a consumer account to reconcile the consumer purchase transaction.

26. The method of claim 22, wherein the qualifying product is a prescription drug or a non-prescription health care related item.

27. The method of claim 22, wherein the restricted use account is a health saving account, flexible spending account, or educational savings account.

28. A computer program product usable with a programmable computer processor having a computer readable program code embodied therein, comprising:
computer readable program code which receives a consumer purchase transaction from a merchant for a rebate qualifying product;
computer readable program code which accesses rebate funds from a manufacturer for the rebate qualifying product; and
computer readable program code which reconciles the consumer purchase transaction with the rebate funds from the manufacturer.

29. The computer program product of claim 28, further including computer readable program code which deposits the rebate funds into a merchant account to reconcile the consumer purchase transaction.

30. The computer program product of claim 28, further including computer readable program code which deposits the rebate funds into a consumer account to reconcile the consumer purchase transaction.

31. The computer program product of claim 28, wherein the rebate qualifying product is a prescription drug or a non-prescription health care related item.

32. A computer system for processing rebates for consumer purchases, comprising:
means for receiving a consumer purchase transaction from a merchant for a rebate qualifying product;
means for accessing rebate funds from a manufacturer for the rebate qualifying product; and
means for reconciling the consumer purchase transaction with the rebate funds from the manufacturer.

33. The computer system of claim 32, further including means for depositing the rebate funds into a merchant account to reconcile the consumer purchase transaction.

34. The computer system of claim 32, further including means for depositing the rebate funds into a consumer account to reconcile the consumer purchase transaction.

35. The computer system of claim 32, wherein the rebate qualifying product is a prescription drug or a non-prescription health care related item.

36. The computer system of claim 32, further including means for identifying additional funding sources for paying a portion of the consumer purchase transaction.

37. The computer system of claim 32, further including identifying a restricted use account to pay for a portion of the consumer purchase transaction attributed to a qualifying product.

38. The computer system of claim 37, further including determining net proceeds from the restricted use account which are used to pay the portion of the consumer purchase transaction attributed to the qualifying product.

39. The computer system of claim 37, wherein the restricted use account is a health saving account, flexible spending account, or educational savings account.
